(19) United States
(12) Patent Application Publication
(10) Pub. No.: US 2026/0341016 A1
(43) Pub. Date: Oct. 29, 2026

(54) METHOD AND APPARATUS FOR GENERATING 3D GEO-SPATIAL INFORMATION FOR DETECTING DAMAGES OF FACILITIES BY USING LIDAR DATA AND CAMERA IMAGES

(71) Applicant: NATIONAL DISASTER MANAGEMENT RESEARCH INSTITUTE, Ulsan (KR)

(72) Inventors: Seong-Sam Kim, Ulsan (KR); Yong-Han Jung, Ulsan (KR); Eon-Taek Lim, Ulsan (KR); Seul Koo, Ulsan (KR); Jung-Wook Park, Ulsan (KR); Cheol-Kyu Lee, Ulsan (KR)

(21) Appl. No.: 19/645,753

(22) Filed: Apr. 13, 2026

(30) Foreign Application Priority Data
Apr. 23, 2025 (KR) 10-2025-0052800

(51) Int. Cl. G06V 20/10; G01S 7/4865; G01S 17/86; G01S 17/89; G06V 10/20; G06V 10/24; G06V 10/26; G06V 10/56; G06V 10/762; G06V 10/80; G06V 20/64; G06V 10/82

(52) U.S. Cl. CPC G06V 20/176; G01S 7/4865; G01S 17/86; G01S 17/89; G06V 10/242; G06V 10/255; G06V 10/26; G06V 10/56; G06V 10/762; G06V 10/803; G06V 20/64; G06V 10/82

(57) ABSTRACT

The present disclosure relates to an operating method of a computing device for precisely detecting and visualizing structural damage using one or more inspection robots. Based on image data acquired through a camera equipped on a first inspection robot and LiDAR data acquired through a LiDAR sensor, camera images including damaged areas are processed as 2D bounding boxes, and a frustum-based point pillar (Frustum Point Pillar) transformation is performed on the corresponding areas. Then, 3D information is reconstructed by mapping a depth map generated by the LiDAR onto selected images, and the reconstructed information is combined with the frustum structure to perform point cloud clustering. Finally, 3D visualization information based on the clustering result is generated and output to one or more devices, thereby enabling intuitive verification of the damage state of the structure.

### BACKGROUND OF THE INVENTION

### 1. Field of the Invention

Embodiments of the present disclosure relate to a computing device and an operating method thereof. More particularly, the present disclosure relates to a technology for generating three-dimensional (3D) spatial information using light detection and ranging (LiDAR) data and camera images from a multi-sensing-based inspection robot, detecting structural damage using the generated 3D spatial information, and analyzing disaster information.

### 2. Description of Related Art

Objective cause investigation and damage assessment of disaster sites are significantly important for disaster prevention and response.

Advanced technology equipment such as drones, robots, and special vehicles are being utilized for objective cause investigation and damage assessment at disaster sites. In particular, track-type ground inspection robots are usefully deployed as disaster investigation robots capable of acquiring indoor survey data at earthquake and building collapse sites and performing investigation missions in areas at risk of facility collapse.

Inspection robots for investigating such disaster sites include a positioning module, a LiDAR sensor, a camera sensor, a communication module, and the like. The inspection robots serve to collect field data on facility collapse through indoor and outdoor positioning and LiDAR sensing, and provide information necessary for predicting and evaluating risks.

However, LiDAR sensors measure the distance to a target by measuring incident light and reflected light. Accurate measurement is possible only when stability against vibration applied to the sensor module is ensured. Accordingly, there is a problem in that measurement is not easy in constrained field environments.

Additionally, in analyzing cracks or fractures, which are the most important factors in determining facility damage, conventional methods have been used in which feature points of camera images are extracted as point clouds to identify overall contours of fractures. However, such methods cannot identify the start points or end points of cracks themselves, and accordingly, there are problems in that it is difficult to accurately determine whether an actual crack exists, and the precise location and scale of cracks.

Furthermore, due to limitations in cost and positioning range, the point cloud data of LiDAR data may not be sufficient, and in this case, it is difficult to accurately identify 3D shapes, which makes accurate damage detection difficult. For example, when LiDAR data is insufficient, even if 3D spatial coordinates are acquired, the estimated location range for the damaged area is relatively large, making it difficult to pinpoint the damage location itself.

In particular, in actual disaster environments, real-time collapse risk of indoor facilities or additional collapse risk during recovery operations may cause significant damage. Therefore, there is a need for technology that enables accurate identification and scale analysis, and rapid provision of analysis results.

### SUMMARY OF THE INVENTION

The present disclosure is designed to solve the above-described problems. The present disclosure is directed to providing an operating method of a computing device and the apparatus thereof that, in detecting the degree of structural damage using LiDAR data and camera images collected from an inspection robot, processes a fused data mapping and visualization process that performs 3D reconstruction and clustering based on frustum-based structural transformation, thereby accurately generating 3D spatial information even when LiDAR data is insufficient, and accurately identifying the location and shape of a structure and its damaged area based thereon.

The technical problems to be solved by the present disclosure are not limited to the aforementioned problems, and can be extended to many other problems derived from the embodiments of the present disclosure as described below.

To solve the above-described problems, an operating method of a computing device for detecting damage of a structure using one or more inspection robots according to an embodiment of the present disclosure includes the steps of: acquiring camera image data collected through one or more cameras equipped on a first inspection robot and LiDAR data collected through one or more LiDAR sensors equipped on the first inspection robot, corresponding to the structure; performing two-dimensional (2D) bounding box processing on image segments of a damaged area identified from the camera image data; performing a three-dimensional (3D) frustum-based point pillar (Frustum Point Pillar) transformation corresponding to the 2D bounding box processed portion; reconstructing 3D information by mapping depth map information generated using the LiDAR data onto an image selected corresponding to the 2D bounding box processed portion; performing point cloud-based clustering by combining the 3D frustum-based point pillar (Frustum Point Pillar) transformed data and the reconstructed 3D information; and configuring and outputting 3D spatial information visualization data for damage detection of the structure based on the clustering result information, wherein the 3D spatial information visualization data includes 3D position information and 3D shape information corresponding to the damage detection of the structure.

Additionally, to solve the above-described problems, the method according to an embodiment of the present disclosure may be implemented in a computer program stored in a computer-readable medium to enable a computer to perform the method.

Additionally, to solve the above-described problems, a computing device for analyzing structural damage by operating one or more inspection robots according to an embodiment of the present disclosure includes: a sensor module driver configured to acquire camera image data collected through one or more cameras equipped on a first inspection robot and LiDAR data collected through one or more LiDAR sensors equipped on the first inspection robot, corresponding to the structure; a frustum-based point pillar transformation unit configured to perform 2D bounding box processing on image segments of a damaged area identified from the camera image data and to perform a 3D frustum-based point pillar (Frustum Point Pillar) transformation corresponding to the 2D bounding box processed portion; a 3D reconstruction unit configured to reconstruct 3D information by mapping depth map information generated using the LiDAR data onto an image selected corresponding to the 2D bounding box processed portion; a clustering processing unit configured to perform point cloud-based clustering by combining the 3D frustum-based point pillar (Frustum Point Pillar) transformed data and the reconstructed 3D information; and an output unit configured to configure and output 3D spatial information visualization data for damage detection of the structure based on the clustering result information, wherein the 3D spatial information visualization data includes 3D position information and 3D shape information corresponding to the damage detection of the structure.

According to the embodiments of the present disclosure, 2D bounding box processing is performed from camera images of a first inspection robot for information analysis of a structure, and a 3D frustum-based point pillar (Frustum Point Pillar) transformation is performed corresponding to the 2D bounding box processed portion, and reconstructed 3D information obtained by mapping corresponding depth map information is combined and processed, thereby performing point cloud-based clustering, so that 3D spatial information visualization information for damage detection of the structure may be configured.

Accordingly, the present disclosure may accurately identify the location and shape of the damaged area based on 3D spatial information, which improves crack prediction accuracy while also providing visualized facility damage extent and crack analysis results that can be easily recognized by operators in an intuitive manner.

It should be understood that the effects of the present disclosure are not limited to the aforementioned effects, and can be extended to many other effects derived from the detailed description of the embodiments of the present disclosure as below.

### BRIEF DESCRIPTION OF THE DRAWINGS

FIG. 1 is a diagram showing an example of a working environment of a system according to an embodiment of the present disclosure.

FIG. 2 is a block diagram illustrating the internal configuration of a computing device 200 in an embodiment of the present disclosure.

FIG. 3 is a diagram illustrating the hardware configuration of an inspection robot connected to a computing device according to an embodiment of the present disclosure.

FIG. 4 is an exemplary diagram of a sensor module according to an embodiment of the present disclosure.

FIG. 5 is an exemplary diagram of a service processing unit according to an embodiment of the present disclosure.

FIG. 6 is a block diagram detailing a crack analysis unit including a 3D spatial information visualization unit according to an embodiment of the present disclosure.

FIG. 7 is a block diagram detailing a 3D spatial information visualization unit according to an embodiment of the present disclosure.

FIG. 8 is a block diagram detailing a damage extent detection unit according to an embodiment of the present disclosure.

FIGS. 9-10 are flowcharts illustrating the operation of a computing device according to an embodiment of the present disclosure.

FIG. 11 is a flowchart for describing a damage detection algorithm in more detail according to an embodiment of the present disclosure.

FIGS. 12-13 are exemplary analysis diagrams for comparing and describing recognition implementation examples and accuracy according to an embodiment of the present disclosure.

FIGS. 14-15 are diagrams for describing an inspection robot control operation of a computing device according to another embodiment of the present disclosure.

### DETAILED DESCRIPTION

In the description of the embodiments of the present disclosure, when it is determined that a detailed description of a known configuration or function may obscure the subject matter of the embodiment, the detailed description thereof will be omitted. Also, in the drawings, portions unrelated to the description of the embodiments of the present disclosure are omitted, and like reference numerals are assigned to like parts.

In the embodiments of the present disclosure, when a component is referred to as being “connected,” “coupled,” or “linked” to another component, it may include not only a direct connection but also an indirect connection in which another component exists therebetween. Additionally, when a component is referred to as “including” or “having” another component, it means that the component may further include another component without excluding the other component, unless otherwise specified to the contrary.

In the embodiments of the present disclosure, the terms “first,” “second,” and the like are used solely for the purpose of distinguishing one component from another component and do not limit the order or importance of the components unless specifically stated otherwise. Therefore, within the scope of the embodiments of the present disclosure, a first component in one embodiment may be referred to as a second component in another embodiment, and likewise, a second component in one embodiment may be referred to as a first component in another embodiment.

In the embodiments of the present disclosure, components distinguished from each other are described for the purpose of clearly explaining characteristics of each component, and it does not necessarily mean that the components are separate. That is, a plurality of components may be integrated into a single hardware or software unit, and a single component may be distributed into a plurality of hardware or software units. Therefore, even if not stated separately, such integrated or distributed embodiments are also included within the scope of the embodiments of the present disclosure.

In the present disclosure, a network may be a concept that includes both wired and wireless networks. The network may refer to a communication network through which data exchange between devices, systems, and devices may be performed, and is not limited to any specific network.

The embodiments described in the present disclosure may be entirely hardware, partly hardware and partly software, or entirely software. In the present disclosure, “unit,” “device,” or “system” refers to a computer-related entity such as hardware, a combination of hardware and software, or software. For example, a unit, a module, a device, or a system as used in the present disclosure may be a running process, a processor, an object, an executable, a thread of execution, a program, and/or a computer, but is not limited thereto. For example, both an application running on a computer and the computer may correspond to a unit, a module, a device, or a system as used in the present disclosure.

Each functional unit described in the present disclosure, including but not limited to the frustum-based point pillar transformation unit, the 3D reconstruction unit, the clustering processing unit, the output unit, the facility segment identification unit, the visual crack segment analysis unit, and the damage extent detection unit, may be implemented as one or more hardware processors, dedicated processing circuits, or software modules executed by one or more processors of the computing device 200. When implemented in software, each functional unit may comprise program code stored in the memory 210 and executed by processor 220. The scope of each functional unit is not limited to any particular hardware or software implementation.

Additionally, in the present disclosure, a device may be a mobile device such as a smartphone, a tablet PC, a wearable device, and a head mounted display (HMD), as well as a fixed device such as a PC or home appliance equipped with a display function. As an example, a device may also be an in-vehicle cluster or an Internet of Things (IoT) device. That is, in the present disclosure, a device may refer to any apparatus capable of running an application and is not limited to any specific type. In the following description, for convenience of explanation, an apparatus on which an application runs is referred to as a device.

In the present disclosure, the communication method of the network is not limited, and connections between respective components may not be connected via the same network method. The network may include not only a communication method utilizing a communication network (for example, a mobile communication network, a wired Internet, a wireless Internet, a broadcast network, a satellite network, etc.) but also short-range wireless communication between devices. For example, the network may include any communication method enabling object-to-object networking, and is not limited to wired communication, wireless communication, 3G, 4G, 5G, or other methods. For example, the wired and/or wireless network may refer to a communication network by one or more communication methods selected from the group consisting of LAN (Local Area Network), MAN (Metropolitan Area Network), GSM (Global System for Mobile Network), EDGE (Enhanced Data GSM Environment), HSDPA (High Speed Downlink Packet Access), W-CDMA (Wideband Code Division Multiple Access), CDMA (Code Division Multiple Access), TDMA (Time Division Multiple Access), Bluetooth, Zigbee, Wi-Fi, VoIP (Voice over Internet Protocol), LTE Advanced, IEEE 802.16m, Wireless MAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), Wi-MAX (World Interoperability for Microwave Access), and ultrasonic communication, but is not limited thereto.

The components described in the various embodiments do not necessarily mean essential components, and some may be optional components. Therefore, an embodiment configured as a subset of the components described in the embodiments is also included within the scope of the embodiments of the present disclosure. Additionally, an embodiment that further includes other components in addition to the components described in the various embodiments is also included within the scope of the embodiments of the present disclosure.

Hereinafter, embodiments of the present disclosure will be described in detail with reference to the accompanying drawings.

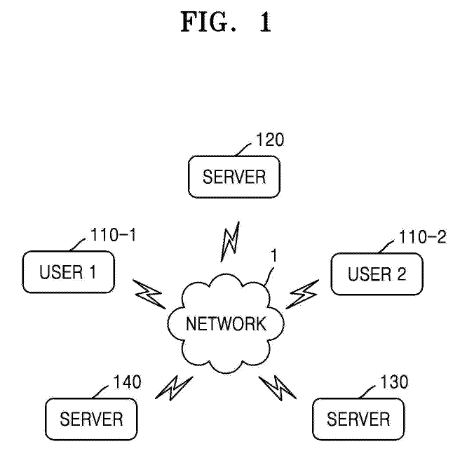

FIG. 1 is a diagram showing an example of a working environment of a system according to an embodiment of the present disclosure. Referring to FIG. 1, a user device 110 and one or more servers 120, 130, 140 are connected via a network 1. FIG. 1 is provided by way of example, and the number of user devices or servers is not limited thereto.

The user device 110 may be a fixed or mobile terminal implemented as a computer system. The user device 110 may include, for example, a smart phone, a mobile phone, a navigation, a computer, a laptop computer, a digital broadcasting terminal, a Personal Digital Assistant (PDA), a Portable Multimedia Player (PMP), a tablet PC, a game console, a wearable device, an internet of things (IoT) device, a virtual reality (VR) device, and an augmented reality (AR) device. For example, in the embodiments, the user device 110 may refer to, in substance, one of a variety of physical computer systems that can communicate with the servers 120-140 via the network 1 using a wireless or wired communication method.

Each server may be implemented as a computer device or a plurality of computer devices which provide instructions, code, files, content, and services by communication with the user device 110 via the network 1. For example, the server may be a system which provides each service to the user device 110 connected via the network 1. As a more specific example, through an application as a computer program installed and running on the user device 110, the server may provide the user device 110 with a service (for example, information provision, etc.) intended by the corresponding application. As another example, the server may distribute files for installing and running the above-described application to the user device 110, receive user input information, and provide a corresponding service.

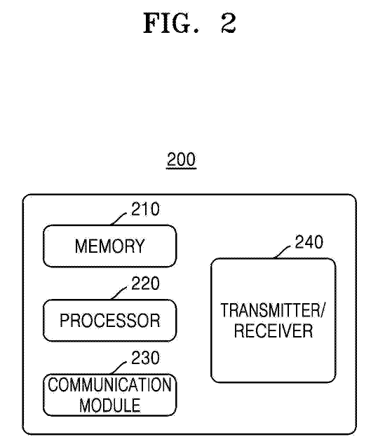

FIG. 2 is a block diagram illustrating the internal configuration of a computing device 200 in an embodiment of the present disclosure. The computing device 200 may be applied to the user device 110 or the servers 120-140 described above with reference to FIG. 1, and each device and the servers may have identical or similar internal configuration by adding or subtracting some components.

Referring to FIG. 2, the computing device 200 may include a memory 210, a processor 220, a communication module 230, and a transmitter/receiver 240. The memory 210 is a non-transitory computer-readable recording medium, and may include a permanent mass storage device such as random access memory (RAM), read only memory (ROM), disk drive, solid state drive (SSD), and flash memory. The permanent mass storage device such as ROM, SSD, flash memory, and disk drive is a separate permanent storage device that is different from the memory 210 and may be included in the above-described device or server. Additionally, the memory 210 may store an operating system and at least one program code (for example, code for browsers installed and running on the user device 110 or applications installed on the user device 110 to provide particular services). These software components may be loaded from a separate computer-readable recording medium that is different from the memory 210. The separate computer-readable recording medium may include a computer-readable recording medium such as floppy drive, disk, tape, DVD/CD-ROM drive, and a memory card.

In another embodiment, the software components may be loaded onto the memory 210 through the communication module 230, but not the computer-readable recording medium. For example, at least one program may be loaded onto the memory 210 based on a computer program (for example, the above-described application) installed by files provided by developers or a file distribution system (for example, the above-described server) responsible for distributing an installation file of the application via the network 1.

The processor 220 may be configured to process the instructions of the computer program by performing basic operations such as arithmetic, logic, and input/output operations. The instructions may be provided to the processor 220 by the memory 210 or the communication module 230. For example, the processor 220 may be configured to execute the received instructions according to the program code stored in the recording device such as the memory 210.

The communication module 230 may provide a function of allowing the user device 110 and the servers 120-140 to communicate with each other via the network 1, and a function of allowing each of the device 110 and/or the servers 120-140 to communicate with another electronic device.

The transmitter/receiver 240 may be a means for interfacing with an external input/output device (not shown). For example, the external input device may include a keyboard, a mouse, a microphone, and a camera, and the external output device may include a display, a speaker, and a haptic feedback device.

As another example, the transmitter/receiver 240 may be a means for interfacing with a device having an integrated function for input and output such as a touchscreen.

Additionally, in other embodiments, the computing device 200 may include a larger number of components than the components of FIG. 2 according to the nature of a device to which the computing device 200 is applied. For example, when the computing device 200 is applied to the user device 110, the computing device 200 may be implemented to include at least some of the above-described input/output devices, or may further include other components such as a transceiver, a Global Navigation Satellite System (GNSS) module, a camera, a variety of sensors, and a database. As a more specific example, when the user device is a smartphone, the computing device 200 may be implemented to further include various types of components commonly included in smartphones, such as an acceleration sensor or a gyro sensor, a camera module, a variety of physical buttons, buttons using a touch panel, input/output ports, and a vibrator for vibration.

The following description will be made based on the computing device that operates based on FIGS. 1 and 2. For example, in the following description, a user may communicate with a robot 300 based on the computing device 200. Additionally, in the following description, the robot 300 may be a device that is connected to the computing device 200 and communicates with an external device. As a specific example, the robot 300 may communicate with another device or server via the network, and may include the components included in the computing device 200 of FIG. 2. Additionally, the robot 300 may include a sensor for identifying surrounding images or video, which will be described later.

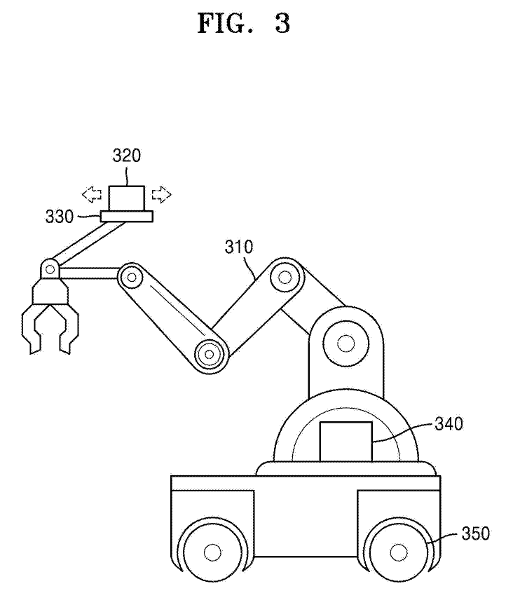

FIG. 3 is a diagram illustrating the hardware configuration of an inspection robot connected to a computing device according to an embodiment of the present disclosure.

Referring to FIG. 3, a multi-sensor 320 including at least one sensor of the robot 300 is coupled by a header 330 capable of fine adjustment and light source formation. The multi-sensor 320 is connected to a robot arm 310 by a separate connecting means, and may perform indoor structural analysis.

The robot arm 310 may be designed to be rotatable 360 degrees and may be provided in a form capable of folding and extending.

Additionally, at a lower portion of the robot 300, a controller 340 for controlling hardware, power, and communication of the robot, and a mobility unit 350 for controlling means of locomotion may be provided, thereby enabling movement for structural damage analysis in indoor environments such as disaster sites. The mobility unit 350 may be, for example, a component that performs a function of moving through indoor spaces using wheels or other means, and is not limited to any specific form.

The robot 300 is configured to be movable in indoor spaces, and may be equipped with a communication function for aggregating various information and transmitting the information to another device or server. Additionally, the robot 300 may be coupled with the multi-sensor 320 to acquire sensing information. The multi-sensor 320 may include a LiDAR sensor, an Inertial Measurement Unit (IMU) sensor, a vision camera, a depth camera, a gyro sensor, and various sensors for sensing other surrounding information, and is not limited to any specific sensor.

The LiDAR sensor may be a sensor that measures position coordinates of a reflector by emitting laser pulses and measuring the time taken for the pulses to be reflected and return. Additionally, the IMU sensor may be a motion sensor that measures the orientation, acceleration, and position of a device by measuring velocity, direction, and magnetism through an accelerometer, a gyroscope, and a magnetometer. Additionally, the vision camera may sense image information of surrounding images, and the depth camera may be a sensor that measures or senses 3D images (i.e., depth images) of surrounding objects based on a stereo method or a time of flight (ToF) method. Other sensors may include sensors for sensing temperature, atmospheric pressure, and other surrounding conditions, and are not limited to any specific embodiment.

As an example, the robot 300 may include a LiDAR sensor (or module) for indoor positioning and mapping. The LiDAR sensor may be manufactured in a compact size and coupled with the robot 300. In particular, the LiDAR sensor may operate on a Simultaneous Localization And Mapping (SLAM) basis to generate indoor maps in real time, and may thereby recognize indoor structures.

Additionally, as an example, a Global Navigation Satellite System (GNSS) may be utilized for indoor and outdoor positioning at disaster sites. However, when communication and radio wave connection from the outside is not smooth due to building shielding and damage at disaster sites, there is a need to autonomously recognize a position and perform mapping in indoor spaces. To this end, the robot 300 may include a camera and a LiDAR as the multi-sensor 320. The LiDAR sensor may be sensitive to vibration caused by external factors because it measures time based on the ToF method. In consideration of the above, the multi-sensor 320 may include an IMU sensor, thereby sensing values of movement and vibration of the robot 300, and performing position movement in consideration of vibration and analysis accuracy, so as to perform stable crack detection and damage information analysis.

Accordingly, the multi-sensor 320 may include sensors for the robot 300 to smoothly perform sensing in indoor structures collapsed by an earthquake, and the sensing information is not limited to any specific embodiment. In the following description, for convenience of explanation, the description will be based on an operation in which the multi-sensor 320 is coupled to the robot 300 and the robot 300 performs sensing through the multi-sensor 320 to analyze indoor structures. That is, the robot 300 described below may be a robot 300 equipped with the multi-sensor 320 and may not be limited to any specific embodiment.

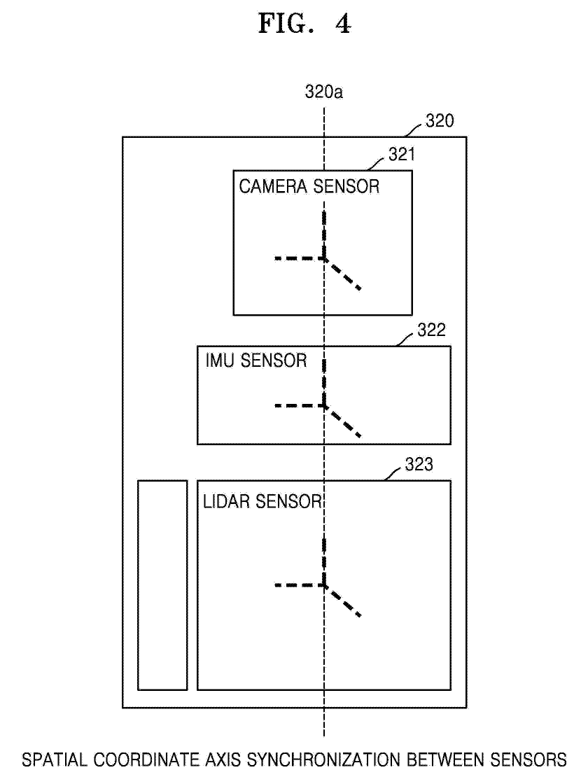

FIG. 4 is an exemplary diagram of a sensor module mounted on the robot 300 according to an embodiment of the present disclosure, which is a drawing illustrating the multi-sensor 320 from a hardware perspective.

Referring to FIG. 4, the multi-sensor 320 according to an embodiment of the present disclosure may include a camera sensor 321 positioned at the top, an IMU sensor 322 axially coupled below the camera sensor 321, and a LiDAR sensor 323 axially coupled below the IMU sensor 322.

Each sensor module of the multi-sensor 320 is coupled in hardware around a single main axis 320a that vertically penetrates through each module, so that the 3D spatial sensing coordinate axes thereof may be synchronized.

With the coordinate axis synchronization of the multi-sensor 320, positioning and rotation information due to movement of the robot 300, entry into sloped sections, and the like may be processed in real time and reflected upon acquisition of sensing information of the multi-sensor 320. For example, the output of each sensor module acquired through coordinate axis synchronization may be mapped with position information based on the synchronized main coordinate axis information. Image information, depth sensing information, rotation information, angle information, acceleration information, and vibration information acquired in synchronization from each sensor module may be mapped with the position information, and may be used for position tracking of the robot 300 and damage detection processing of indoor space facilities.

Additionally, to facilitate sensing information processing of the multi-sensor 320, data processing based on Simultaneous Localization And Mapping (SLAM) technology may be utilized. SLAM is a technology for estimating a position using various sensors in an unknown environment and generating a 3D map of the environment. As computer processing speed improves and sensor technologies such as cameras and LiDAR advance, SLAM has been applied in various fields. In particular, SLAM is a technology used for indoor positioning and mapping in cases where no existing map is available, such as at disaster sites, and enables building spatial information through LiDAR and camera-based scanning, data structuring, and 3D indoor map visualization.

Accordingly, the robot 300 may convert the information sensed from the multi-sensor 320 into data to build a 3D indoor map, detect facilities estimated within the built indoor map and the degree of damage for each facility based on crack analysis, and share the results. For example, the robot 300 may be deployed into an indoor structure collapsed by an earthquake to build spatial information based on the robot position indoors, and analyze and output the degree of damage for each facility.

Indoor structures collapsed by an earthquake may be in rough terrain environments, and accuracy of sensing may be improved by utilizing data under the following preset rough terrain conditions. That is, the robot 300 may be deployed indoors in consideration of the environment of the indoor structure collapsed by the earthquake, and may perform sensing through sensors. The rough terrain conditions may be exemplified by classification conditions such as flat ground, speed bumps, and gravel detected based on average acceleration and maximum acceleration sensing.

The robot 300 and the multi-sensor 320 configured as described above may be controlled by the computing device 200 according to an embodiment of the present disclosure. As an example, the robot 300 may perform indoor positioning and mapping and damage analysis utilizing SLAM based on the above-described multi-sensor 320, and the control of the robot 300 may be performed by the connected computing device 200. As an example, the robot 300 and the computing device 200 may exchange information through a mutual communication connection. The robot 300 may perform sensing in indoor spaces based on a control operation of the computing device 200, and the computing device 200 may control the position of the multi-sensor 320 or the movement of the mobility unit 350 in real time to improve accuracy of crack detection.

For example, vibration affecting LiDAR sensor sensitivity or lighting conditions for camera photographing may differ depending on the conditions at the disaster site. Accordingly, distortion may occur in sensing information, and various computing processes for minimizing the distortion may be processed in the computing device 200 and configured as a control signal for the robot 300.

As an example, the internal position and rotation of the multi-sensor 320 equipped on the robot 300 may be controlled, which may be achieved by drive control of the robot arm 310 by the computing device 200.

Additionally, as an example, the computing device 200 may perform drive control of the header 330 coupled with the multi-sensor 320, which serves to enable more accurate sensing operations by performing fine position adjustment of the sensor modules equipped on the multi-sensor 320 and light source control of LED lighting attached to the header 330.

Furthermore, the computing device 200 may control the movement position and movement speed of the robot 300. The movement position and movement speed may be optimized in a direction to prevent distortion or errors in consideration of vibration sensing according to changes in indoor environment and recognition rate of vision sensors.

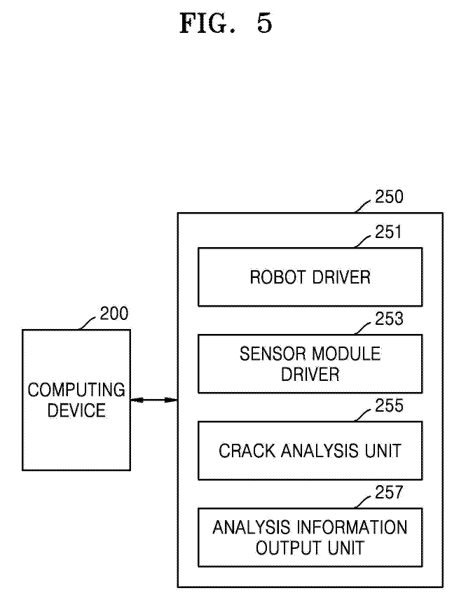

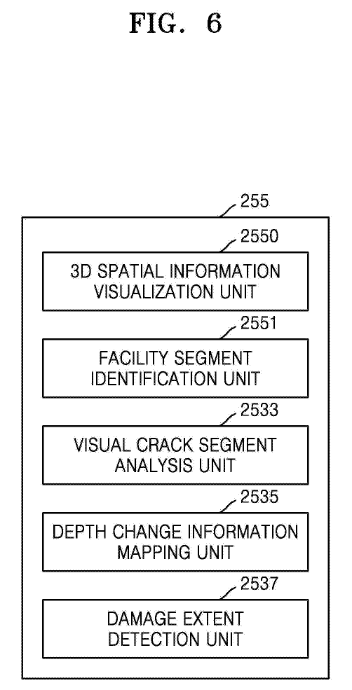

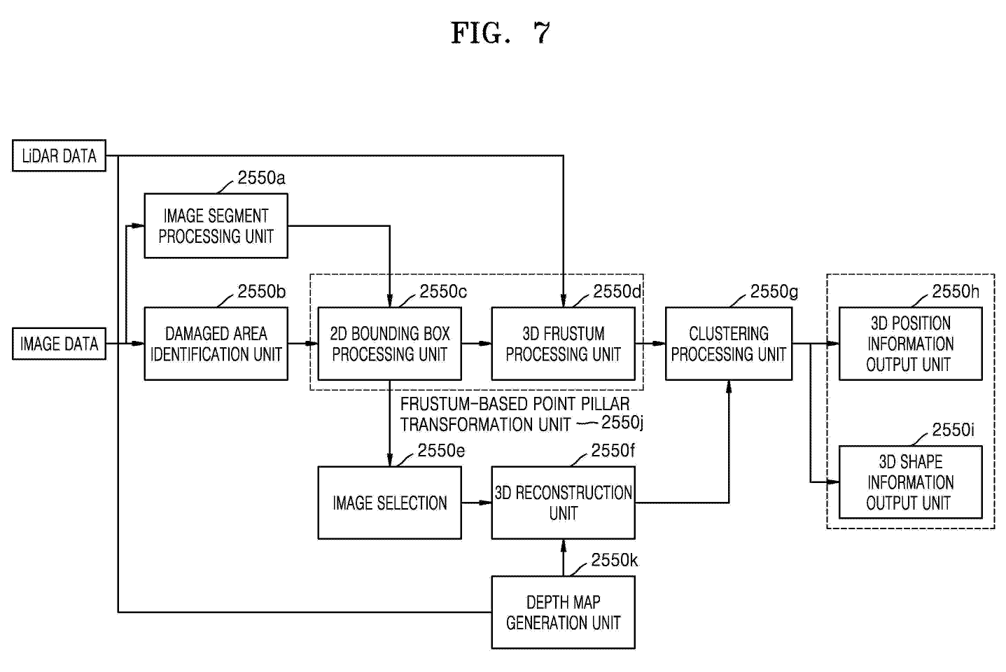

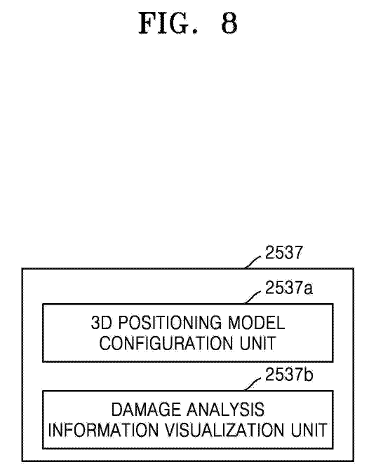

FIG. 5 is a block diagram detailing a service processing unit 250 of the computing device 200 for outputting facility analysis information corresponding to indoor 3D spatial analysis by operating the robot 300 according to an embodiment of the present disclosure. FIG. 6 is a block diagram detailing a crack analysis unit including a 3D spatial information visualization unit according to an embodiment of the present disclosure. FIG. 7 is a block diagram detailing a 3D spatial information visualization unit. FIG. 8 is a block diagram detailing a damage extent detection unit according to an embodiment of the present disclosure.

First, referring to FIG. 5, the computing device 200 according to an embodiment of the present disclosure may further include a service processing unit 250. The service processing unit 250 may include processor modules that perform various service processes for crack analysis, damage detection, and robot 300 control data processing according to an embodiment of the present disclosure among the logic and input/output operations processed by the processor 220. The computing device 200 may perform service processing using the processed data from the service processing unit 250 included in the processor 220 or the service processing unit 250 equipped as an external processor, and provide the generated service processing result to the user device 110 or one or more servers 120, 130, 140.

By this processing, the user device 110 or one or more servers 120, 130, 140 may receive the analysis information configured by the operation of the service processing unit 250 according to an embodiment of the present disclosure and display and output the information through a display device, or transmit and receive data via an external network.

More specifically, first, referring to FIG. 5, the service processing unit 250 includes a robot driver 251, a sensor module driver 253, a crack analysis unit 255, and an analysis information output unit 257.

The robot driver 251 generates control signals for performing hardware drive control for position movement and sensing operation control of the robot 300 shown in FIGS. 3 and 4 described above, transmits the control signals to the robot 300, and receives responses therefrom to perform drive control.

The robot driver 251 may perform drive control of each of the multi-sensor 320, the header 330, the robot arm 310, the controller 340, and the mobility unit 350 of the robot 300 described above, and accordingly, movement of the robot 300, internal position and sensing control of the multi-sensor 320 may be performed.

Additionally, the sensor module driver 253 acquires sensor signals from each sensor equipped on the multi-sensor 320, organizes the sensor signals into sensing information synchronized for each position on a SLAM (Simultaneous Localization And Mapping) basis, and performs data processing of transmitting the organized sensing information to the crack analysis unit 255.

The sensor signals may include a sensor signal of the LiDAR sensor 323, a sensor signal of the IMU sensor 322, and a vision sensing signal of the camera sensor 321. Additionally, the sensor module driver 253 mutually maps and converts the signals acquired from each sensor module of the multi-sensor 320 to form SLAM data, and the formed SLAM data may be transmitted to the crack analysis unit 255.

The SLAM data may further include not only the basic sensor signals of the LiDAR sensor 323, the IMU sensor 322, and the camera sensor 321, but also information that has been converted and processed to form 3D spatial data.

For example, the SLAM data may further include indoor position coordinate information calculated from the IMU sensor 322, raw image mapping images acquired from the camera sensor 321, camera and LiDAR pose information calculated from the IMU sensor 322, LiDAR data acquired from the LiDAR sensor 323, and feature point cloud information acquired from raw image images.

Additionally, the sensor module driver 253 may request position movement of the robot 300 or precise position control of the multi-sensor 320 from the robot driver 251 when the sensing accuracy of each sensor information is below a threshold, in order to improve the sensing accuracy.

Additionally, the crack analysis unit 255 acquires the information converted and processed by the sensor module driver 253 described above, and processes 3D indoor map building and facility damage detection using the acquired sensing information. For damage detection processing, the crack analysis unit 255 first configures refined 3D spatial information acquired through frustum-based point pillar structural transformation according to an embodiment of the present disclosure, and may identify facility segments mapped to the 3D spatial information based on the sensing information. Corresponding to the facility segments, the crack analysis unit 255 may acquire visual crack identification information analyzed from vision image information of the sensing information and crack depth change information determined by depth sensing information corresponding to the visual crack identification information. Based on the presence or absence of cracks and the scale of cracks acquired based on the visual crack identification information and the crack depth change information, the crack analysis unit 255 may estimate and calculate the degree of damage of the facility segments.

Accordingly, the analysis information output unit 257 may configure facility information analysis result data of the facility segments based on the degree of damage, combine the configured data with the built 3D indoor map information, and output the combined data to one or more devices. The one or more devices may include, for example, the user device 110 or one or more servers 120, 130, 140.

More specifically, referring to FIG. 6, the crack analysis unit 255 includes a 3D spatial information visualization unit 2550, a facility segment identification unit 2551, a visual crack segment analysis unit 2533, a depth change information mapping unit 2535, and a damage extent detection unit 2537.

First, the 3D spatial information visualization unit 2550 processes a fused data mapping and visualization process that performs 3D reconstruction and clustering based on frustum-based structural transformation processing according to an embodiment of the present disclosure in order to detect the degree of structural damage using LiDAR data and camera images collected from the inspection robot 300. Accordingly, the 3D spatial information visualization unit 2550 accurately generates 3D spatial information even when LiDAR data is insufficient, configures 3D spatial information capable of accurately identifying the location and shape of the structure and its damaged area based thereon, generates visualization information including 3D position information and 3D shape information corresponding to damage detection of the structure, and transmits the generated information to each component inside the crack analysis unit 255.

More specifically, the 3D spatial information visualization unit 2550 acquires camera image data collected through one or more cameras equipped on the first inspection robot and LiDAR data collected through one or more LiDAR sensors equipped on the first inspection robot, corresponding to the structure. The 3D spatial information visualization unit 2550 performs 2D bounding box processing on image segments of the damaged area identified from the camera image data, performs a 3D frustum-based point pillar (Frustum Point Pillar) transformation corresponding to the 2D bounding box processed portion, reconstructs 3D information by mapping depth map information generated using the LiDAR data onto an image selected corresponding to the 2D bounding box processed portion, performs point cloud-based clustering by combining the 3D frustum-based point pillar (Frustum Point Pillar) transformed data and the reconstructed 3D information, and configures and outputs 3D spatial information visualization data for damage detection of the structure based on the clustering result information.

The configuration and detailed operations of the 3D spatial information visualization unit 2550 will be described in more detail with reference to FIG. 7.

FIG. 7 is a block diagram detailing a 3D spatial information visualization unit according to an embodiment of the present disclosure.

Referring to FIG. 7, the 3D spatial information visualization unit 2550 according to an embodiment of the present disclosure includes an image segment processing unit 2550a, a damaged area identification unit 2550b, a 2D bounding box processing unit 2550c, a 3D frustum processing unit 2550d, an image selection unit 2550e, a 3D reconstruction unit 2550f, a clustering processing unit 2550g, a 3D position information output unit 2550h, a 3D shape information output unit 2550i, and a depth map generation unit 2550k.

First, the image segment processing unit 2550a collects camera image data collected through one or more cameras equipped on the first inspection robot corresponding to the structure from the inspection robot 300 that captured images of the structure. The image segment processing unit 2550a separates image information into a structural area corresponding to a facility and a background area according to a structure segmentation algorithm, classifies the separated image segments, and transmits the classified segments to the 2D bounding box processing unit 2550c. The structure segmentation algorithm may use known background separation algorithms such as OneFormer.

Additionally, the damaged area identification unit 2550b may detect a damaged area based on an object detection algorithm from the camera image data. The damaged area is an area with a possibility of damage, and may be detected by performing object recognition based on pre-training using an artificial neural network. A known method such as YOLOv8 may be used as the object recognition algorithm, and the detected damaged area information may be transmitted to the 2D bounding box processing unit 2550c.

Additionally, the 2D bounding box processing unit 2550c maps the detected damaged area information and the classified image segments to generate 2D bounding box information representing the damaged area on the 2D image segments, and transmits the generated 2D bounding box information to the 3D frustum processing unit 2550d.

Accordingly, the 3D frustum processing unit 2550d performs a 3D frustum-based point pillar structural transformation on the 2D bounding box corresponding to the damaged area to acquire transformed 3D frustum-based point pillar structural information, and transmits the acquired information to the clustering processing unit 2550g. The frustum-based point pillar structure forms a virtual 3D space expanded in a conical shape according to a field of view angle of the camera, and is structural information indicating a range in which the damaged area may exist in the 3D space. The 3D spatial information visualization unit 2550 may acquire the frustum-based point pillar structural information through transformation using a well-known Frustum Point Pillar-based 3D object detection technique.

More specifically, the 3D frustum processing unit 2550d back-projects a conical frustum into 3D space from a camera image in which the damaged area of the 2D bounding box is detected, and extracts a 3D point cloud corresponding to the frustum. Additionally, the 3D frustum processing unit 2550d partitions the point cloud within the frustum into pillar units (e.g., small 2D grid units), collects point information corresponding to each pillar, builds a feature map using a 2D artificial neural network (e.g., CNN, etc.), and performs regression analysis corresponding to 3D boxes to predict 3D boxes. Thereby, the 3D frustum processing unit 2550d generates 3D frustum-based point pillar structural transformation information configured to estimate the position, size, or orientation of each of the structure and the damaged area corresponding to the damaged area in the 3D spatial information, and transmits the generated information to the clustering processing unit 2550g.

Meanwhile, the image selection unit 2550e selects an image segment image corresponding to the 2D bounding box information of the damaged area and transmits the selected image to the 3D reconstruction unit 2550f.

The inspection robot 300 may transmit LiDAR data corresponding to the image segments to the depth map generation unit 2550k, and the depth map generation unit 2550k may generate depth map information based on the LiDAR data and transmit the generated depth map information to the 3D reconstruction unit 2550f.

Accordingly, the 3D reconstruction unit 2550f may transmit 3D information reconstructed as 3D shape information through depth map information mapping for the image segment image to the clustering processing unit 2550g.

Since 3D shape information is formed only by mapping image data and LiDAR data, it may be inaccurate when LiDAR data is insufficient. The clustering processing unit 2550g performs point cloud-based 3D clustering by supplementing and combining the 3D information using the 3D frustum-based point pillar structural information of the damaged area described above. That is, the clustering processing unit 2550g combines the 3D frustum-based point pillar (Frustum Point Pillar) transformed data and the reconstructed 3D information to perform point cloud-based clustering, thereby configuring 3D structural information visualization data for damage detection of the structure based on the clustering result information.

Additionally, the output unit includes a 3D position information output unit 2550h and a 3D shape information output unit 2550i, and outputs position coordinates in 3D space and 3D shape data corresponding to each structure and damaged area object. According to each3D spatial information visualization data, facility segment identification and classification processing and crack detection to be described later may be subsequently performed.

However, since the present disclosure is capable of accurately restoring 3D spatial information visualization data, it is apparent that the present disclosure may be extended to various fields such as structural health monitoring, autonomous driving, and facility maintenance, in addition to crack detection. Accordingly, the computing device 200 according to an embodiment of the present disclosure may further perform various service processes such as structural health monitoring, autonomous driving, and facility maintenance based on 3D spatial information visualization, in addition to crack classification based on facility segment identification to be described later.

Additionally, the 3D spatial information visualization processing according to an embodiment of the present disclosure may be supplementally performed when LiDAR sensors are insufficient or LiDAR data is insufficient. For example, the processing may be performed under conditions in which the number of LiDAR sensors in the detection system is below a threshold, or the amount of LiDAR data or the 3D prediction accuracy based on LiDAR data is below a threshold.

Referring again to FIG. 6, the facility segment identification unit 2551 identifies 3D position information and 3D shape information of the structure and damaged area corresponding to damage detection of the structure using the 3D spatial information visualization data, and segments facility segments from vision image information acquired from the sensing information based on the 3D position information and the 3D shape information, thereby performing identification and classification processing.

The facility segment identification unit 2551 may perform image classification processing on each facility included in the vision image information captured by the robot 300 using a pre-built artificial neural network deep learning-based image classification model, and may separate the classified facility images to form individual facility segments. For example, vision image images may be classified into major categories, medium categories, minor categories, and detailed items according to each facility. For example, a specific facility in an image may be classified into detailed categories such as architecture (major category), structure (medium category), door (minor category), and window (detailed item), and the facility image portion classified into each item may be separated from the original image to form individual facility segments, and classification information may be labeled.

Additionally, the visual crack segment analysis unit 2533 acquires visual crack identification information from vision image information acquired from the sensing information, and by mapping the acquired visual crack identification information and the facility segments identified by the facility segment identification unit 2551, may configure visual crack identification information for each facility segment. The visual crack identification information may be detected by inputting the raw image applied from the sensor module driver 253 to an artificial neural network-based trained model in which facility images and crack detection results are pre-trained. The trained model is a model that preferentially separates and configures crack segments generated particularly by fractures among facility damage, and an artificial neural network training model such as DCNN may be used for such training.

Additionally, the visual crack segment analysis unit 2533 may map the crack segments extracted from the raw image and the facility segments in this manner, and the crack segments may be configured as crack segments for each facility and may be used to represent cracks of the facility.

The visual crack segment analysis unit 2533 according to an embodiment of the present disclosure, in performing analysis on conventional image feature point groups, performs pixel information analysis corresponding to the high-resolution captured raw image and configures vector image information of cracks connecting pixels, thereby enabling more accurate definition of start points and end points of cracks than conventional shape data of point groups.

Accordingly, the visual crack segment analysis unit 2533, in detecting crack segments as visual crack identification information, detects a visual crack object area estimated as a crack from the vision image, and may configure the object area as object information including start point and end point information. Such object information may be configured as 3D object information using the 3D spatial information visualization data converted and configured from the 3D spatial information visualization unit 2550 described above. That is, the object information may be used to configure 3D model data representing crack segments.

Additionally, the crack segments may be configured as a visualized color image in which color information is mapped to each pixel. The visual crack segment analysis unit 2533 may map a color image in which color conversion has been processed for each pixel position to the crack segments using geometric transformation information corresponding to the visual crack object. The geometric transformation information may be acquired based on rotation information of the IMU sensor 322 corresponding to the visual crack object and distance movement information of the robot 300. The distance movement information may include distance information corresponding to a movement of the robot 300 to a position at which sensing is performed, including a position identified for capturing images of the damaged area. For example,2D RGB information of the camera may be corrected based on3D rotation information and distance movement information, and this enables intuitive visualization by providing color information more similar to reality in consideration of light source positions and the like.

Additionally, the visual crack segment analysis unit 2533 may request various operations of the sensor module driver 253 to improve the accuracy of crack segment detection. As an example, the visual crack segment analysis unit 2533 may request camera zoom-in or zoom-out control of the multi-sensor 320 from the sensor module driver 253 when the prediction accuracy of the detected crack segments is below a first threshold and above a second threshold. Accordingly, the presence or absence and scale of cracks in areas estimated to have cracks may be more accurately determined.

Additionally, the visual crack segment analysis unit 2533, when the prediction accuracy of the detected crack segments is below the first threshold and above the second threshold, may request movement to a first position through control of the mobility unit 350 of the robot 300 from the robot driver 251. This is for accurately determining the presence or absence and scale of cracks. When an object estimated as a crack is seen from a distance and is not accurate, or when the estimated depth error due to vibration sensing is high, the robot may be moved to the first position at which a stable, high-quality image can be acquired in consideration thereof. Accordingly, the presence or absence and scale of cracks may be more accurately determined through position movement to areas estimated to have cracks.

Additionally, for 3D analysis corresponding to the presence or absence and scale of cracks, the depth change information mapping unit 2535 may perform visualization of crack segments corresponding to the crack object and depth change information mapping in correspondence with the 3D spatial information visualization data of the 3D spatial information visualization unit 2550. The depth change information mapping unit 2535 may acquire a crack area image corresponding to the visual crack object, and may acquire and perform mapping processing of depth change information for each pixel acquired from the multi-sensor 320 corresponding to the crack area image. The depth change information may be determined from distance information of the LiDAR sensor 323 or distance information using a depth camera.

The depth camera may comprise two or more cameras configured to simultaneously capture the same target from two or more positions. A first camera of the depth camera may be a front camera provided for movement of the robot 300, and a second camera may be a camera sensor provided on the multi-sensor 320. Alternatively, the depth camera may be a conventional camera that sequentially captures images from two or more different positions and detects depth using the difference therebetween. The internal position of the multi-sensor 320 or the position of the robot 300 may be controlled such that depth images corresponding to the crack area image are sequentially captured from the two or more different positions, and depth information is calculated from the depth images.

Meanwhile, the crack analysis unit 255, when an object estimated as the crack is identified from the vision sensor of the multi-sensor 320, may search for an optimal position for acquiring the visual crack identification information and the crack depth change information corresponding to the crack. That is, the crack analysis unit 255 may identify from a distance a position suitable for the robot 300 to determine the presence or absence and size of cracks in advance, and may determine an optimal position (for example, a closest position where minimum vibration is expected) for determining the same. Additionally, the crack analysis unit 255 may transmit a movement control request for moving to the position and performing sensing to the robot driver 251.

For example, the crack analysis unit 255 may search for one or more positions predicted to be capable of identifying the visual crack identification information and the crack depth change information of the object tracked as the crack at or above a threshold, among the movable positions of the inspection robot calculated based on sensing stability prediction of the sensor module of the multi-sensor 320, as movement candidate positions. Additionally, the robot driver 251 may move the inspection robot to the first position determined from among the searched positions.

Meanwhile, the damage extent detection unit 2537 estimates and calculates the degree of damage of the facility segments based on the presence or absence and scale of cracks acquired based on the visual crack identification information and the crack depth change information. Accordingly, the crack analysis unit 255 may configure crack analysis information including the calculated degree of damage and transmit the crack analysis information to the analysis information output unit 257. Accordingly, the analysis information output unit 257 may configure facility information analysis result data of the facility segments based on the degree of damage, and output the configured data to one or more devices.

More specifically, referring to FIG. 8, the damage extent detection unit 2537 includes a 3D positioning model configuration unit 2537a and a damage analysis information visualization unit 2537b. The 3D positioning model configuration unit 2537a configures a 3D positioning model of an indoor space using the 3D structural information visualization data output from the 3D spatial information visualization unit 2550 described above. However, when the prediction accuracy of LiDAR data-based 3D information is above a threshold, at least a part of the process may be omitted for rapid processing.

Additionally, the damage analysis information visualization unit 2537b may perform visualization processing of displaying the estimated degree of damage of the facility segments on the 3D positioning model based on each of the visual crack identification information and the crack depth change information. More specifically, the damage analysis information visualization unit 2537b, corresponding to a 3D crack segment object determined as a crack object, extracts crack skeletonization information forming a crack, and determines the scale of the crack using the average length and thickness information of the crack estimated from the extracted crack skeletonization information, and may display the determined scale of the crack on the 3D positioning model.

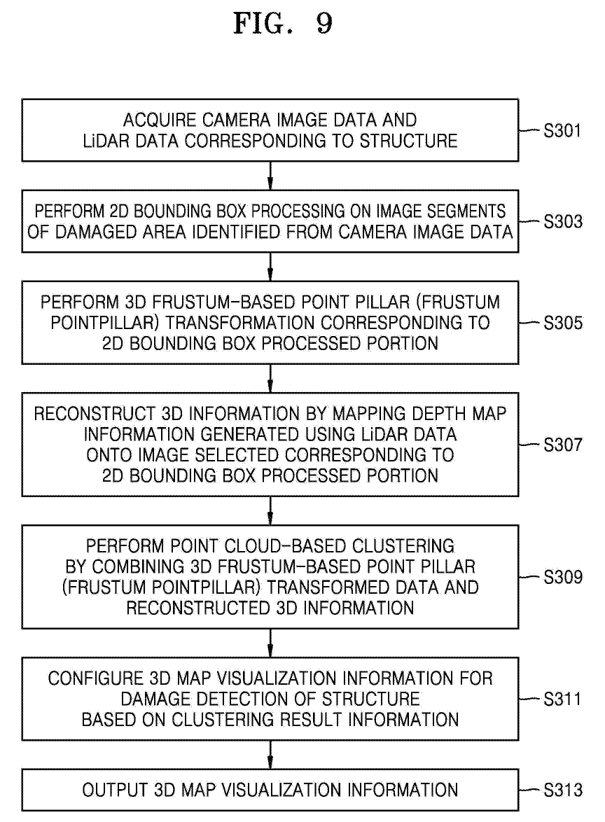

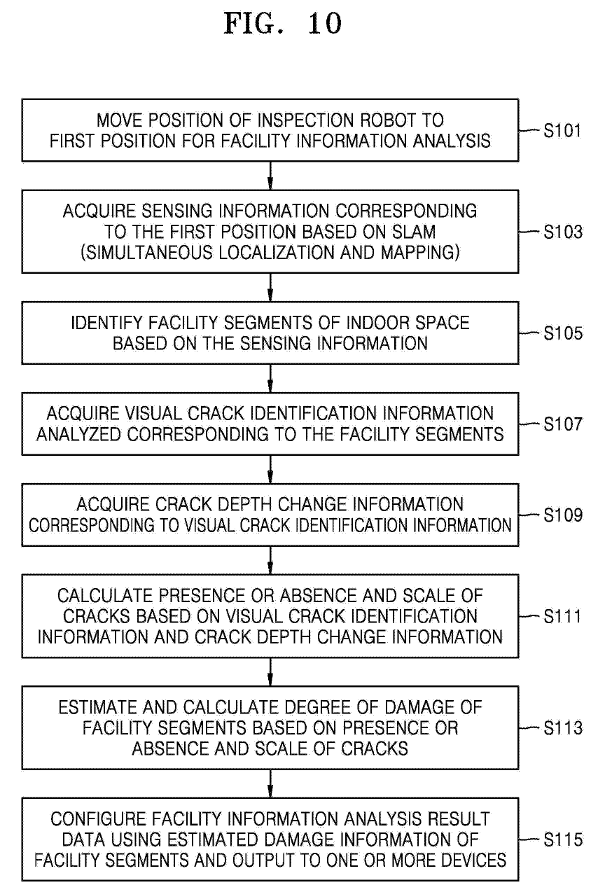

FIGS. 9-10 are flowcharts illustrating the operation of a computing device according to an embodiment of the present disclosure.

First, referring to FIG. 9, the computing device 200 including the service processing unit 250 according to an embodiment of the present disclosure acquires camera image data and LiDAR data corresponding to a structure (S301). Then, the computing device 200 performs 2D bounding box processing on image segments of a damaged area identified from the camera image data (S303). Then, the computing device 200 performs a 3D frustum-based point pillar (Frustum Point Pillar) transformation corresponding to the 2D bounding box processed portion (S305). Then, the computing device 200 reconstructs 3D information by mapping depth map information generated using the LiDAR data onto an image selected corresponding to the 2D bounding box processed portion (S307). Then, the computing device 200 performs point cloud-based clustering by combining the 3D frustum-based point pillar (Frustum Point Pillar) transformed data and the reconstructed 3D information (S309). Then, the computing device 200 configures 3D map visualization information based on 3D spatial information visualization data for damage detection of the structure based on the clustering result information (S311), and outputs the configured 3D map visualization information (S313).

Meanwhile, FIG. 10 is for describing a method of driving the inspection robot 300 and detecting cracks of the computing device 200 using such 3D map visualization information. The computing device 200 first moves the position of the inspection robot 300 for facility information analysis to a first position through the robot driver 251 (S101). Then, the computing device 200 acquires sensing information corresponding to the first position through the sensor module driver 253 (S103). The sensing information may be acquired based on the 3D map visualization information and may be SLAM (Simultaneous Localization And Mapping)-based, but the present disclosure is not limited to the sensing information itself. Then, the computing device 200 identifies facility segments of an indoor space based on the sensing information through the crack analysis unit 255 (S105). Then, the computing device 200 acquires visual crack identification information analyzed corresponding to the facility segments through the crack analysis unit 255 (S107), and acquires crack depth change information corresponding to the visual crack identification information (S109). Accordingly, the computing device 200, through the crack analysis unit 255, calculates the presence or absence and scale of cracks based on the visual crack identification information and the crack depth change information (S111), and then estimates and calculates the degree of damage of the facility segments based on the presence or absence and scale of cracks (S113). Then, the computing device 200, through the analysis information output unit 257, configures facility information analysis result data using the estimated damage information of the facility segments and outputs the configured data to one or more devices (S115).

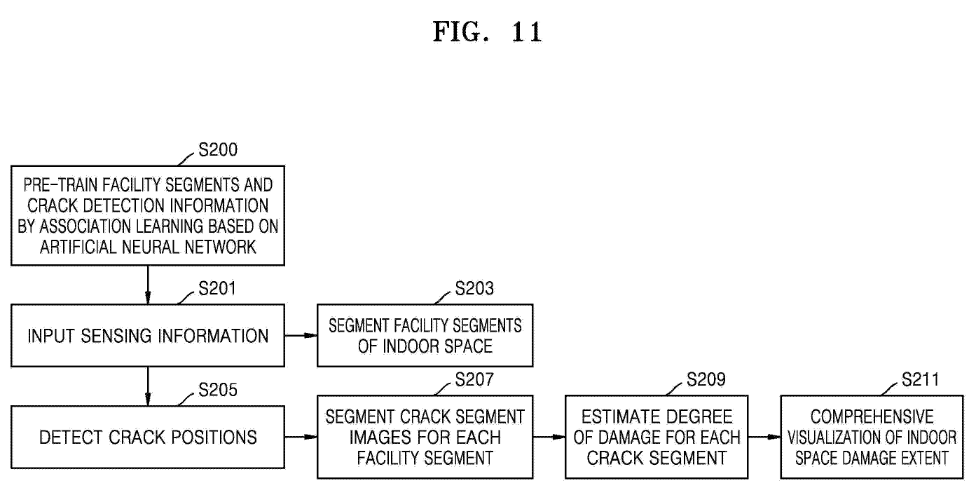

FIG. 11 is a flowchart for describing a damage detection algorithm in more detail according to an embodiment of the present disclosure. FIG. 11 relates to a detailed damage detection algorithm. First, the computing device 200 builds a trained model in which facility segments extracted from sensor image images and actual crack detection information are pre-trained by association learning based on an artificial neural network (S200). For association learning for extraction and classification of facility segments, an artificial neural network deep learning-based image classification training method such as DeepLab may be exemplified. For association learning for crack detection, a DCNN-based artificial neural network training method that trains to extract crack segment images and crack objects from facilities based on ResNet may be exemplified. Accordingly, a first trained model for facility segment detection and a second trained model for extracting crack segments may be respectively pre-configured.

Then, when sensing information is input to the crack analysis unit 255 (S201), the computing device 200 first performs segmentation processing on facility segment images of an indoor space using the first trained model described above (S203). Then, the computing device 200 detects the crack positions described above using the second trained model through the crack analysis unit 255 (S205), and performs segmentation processing into crack segment images for each facility segment (S207). Then, the computing device 200 estimates the degree of damage for each crack segment through the damage extent detection unit 2537 of the crack analysis unit 255 (S209), and comprehensively performs visualization processing on the degree of damage for each facility in the indoor space and outputs the results (S211).

For example, when raw image information is acquired from the sensor module driver 253, the computing device 200 may perform crack analysis in which the crack analysis unit 255 geometrically transforms color information of the raw image and detects and displays crack segments corresponding to each facility segment. Each of the analysis results may be respectively processed for visualization, and the analysis results may be configured as a 3D model and provided to each user device 110 or one or more servers 120, 130, 140.

Additionally, the damage location and degree of damage for each recognized facility may be configured as 3D position coordinates based on the 3D spatial information visualization data described above and mapped onto visualized 3D analysis result data. A crack detection area may be displayed on the facility segment model, and position coordinates of crack objects detected as crack objects may be mapped within the crack detection area. Such detection information may be mapped as detection log data and individual crack segment image data and stored and managed in the computing device 200.

Furthermore, the detected crack object information may be converted and processed to determine the degree of damage by measuring the average length and thickness of the fractures. A skeletonization method may be preferable as the conversion method. This enables identification of the presence or absence and scale of cracks more accurately than the original crack image, and enables rapid determination of the degree of damage using the estimated values. For such estimation of crack scale, binary conversion and vectorization processes of crack segment images may be used, and algorithms such as trend line prediction may be utilized.

Additionally, as the viewing angle of the inspection robot 300 is adjusted to face the target head-on, shape detection and color conversion mapping of crack segments may be performed more accurately. The computing device 200 may determine an optimized first position when a crack estimation object is detected in consideration of a position at which vibration is minimized while more accurately detecting the shape of the crack segment, and may move the robot 300 to the position. Accordingly, a more accurate crack segment is detected, and more accurate crack object configuration and damage extent analysis based thereon become possible.

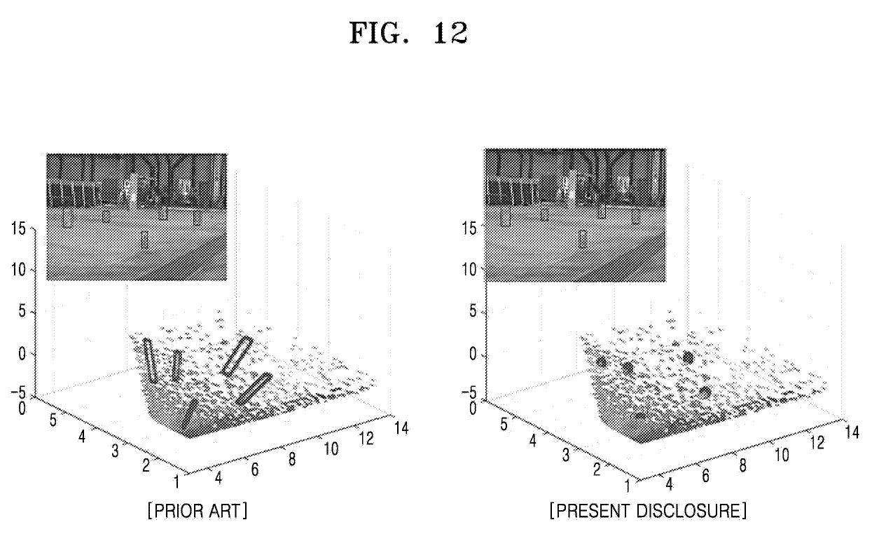

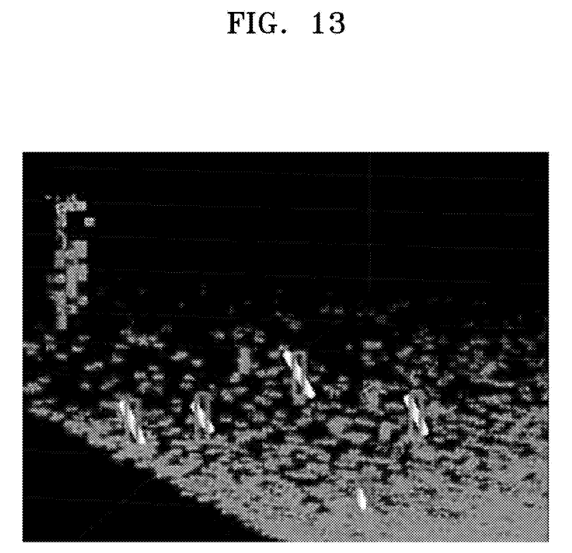

FIGS. 12-13 are exemplary analysis diagrams for comparing and describing recognition implementation examples and accuracy according to an embodiment of the present disclosure. Referring to FIG. 12, concrete piles are identified in red, 3D bounding boxes in green, and 3D diagonal patterns in white, indicating that image information may be visualized as 3D spatial information. With the reinforcement of 3D frustum-based point pillar structural information, it can be confirmed that all spatial information that is difficult to identify from the image segments themselves may be fully restored in 3D. Additionally, the computation time of such computation processes may be performed within one second when the number of restoration points is within 50, enabling rapid computation.

Additionally, referring to FIG. 13, it can be confirmed that the result of recognizing concrete piles in 2D according to the prior art is inaccurately recognized over a very wide range, whereas the 3D location according to the 3D frustum-based point pillar structural transformation according to an embodiment of the present disclosure is pinpointed at a relatively highly accurate location.

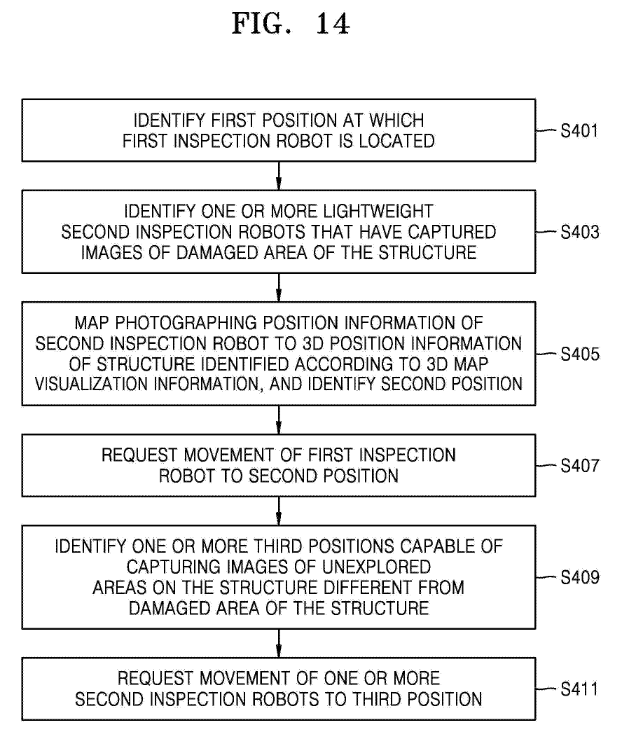

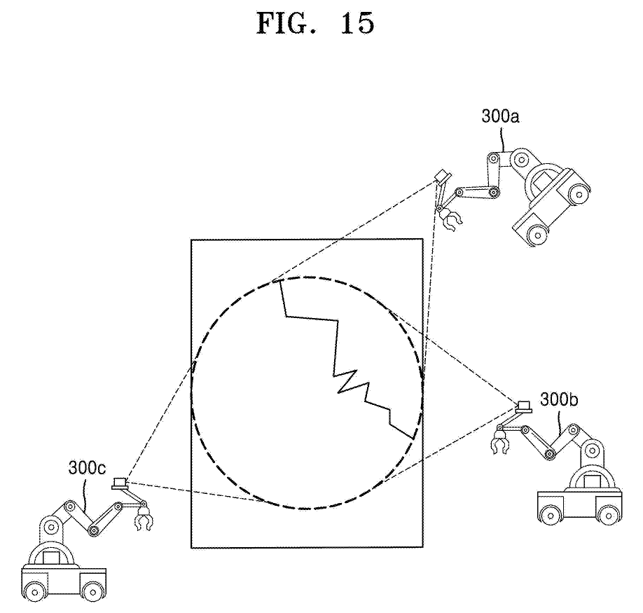

FIGS. 14-15 are diagrams for describing an inspection robot control operation of a computing device according to another embodiment of the present disclosure. As shown in FIG. 15, when there are a second inspection robot 300b equipped only with a camera and a third inspection robot 300c in addition to a first inspection robot 300a equipped with a LiDAR and a camera, each inspection robot senses the surrounding environment at different angles and positions and has different fields of view, so that different frustums may be formed.

Furthermore, damage of a specific structure may be identified at the positions of the first inspection robot 300a and the second inspection robot 300b but may not be identified at the position of the third inspection robot 300c. However, the specific structure itself may be identified by all of the first to third inspection robots. In order to acquire more accurate structural damage information using both camera images and LiDAR data, the computing device 200 may control the movement and sensing of each inspection robot to key positions through the robot driver 251. For such operation, the computing device 200 may be implemented in the form of a central server.

Accordingly, the operation of the computing device 200 as shown in FIG. 14 may be performed. Referring to FIG. 14, the computing device 200 first identifies a first position at which the first inspection robot 300a is located (S401). Then, the computing device 200 identifies one or more lightweight second inspection robots that have captured images of the damaged area of the structure (S403). The one or more lightweight second inspection robots may include the second inspection robot 300b and the third inspection robot 300c that are not equipped with a LiDAR sensor. Then, the computing device 200 maps the photographing position information of the second inspection robot to the 3D position information of the structure identified according to the 3D map visualization information, and identifies the second position (S405). Then, the computing device 200 requests movement of the first inspection robot to the second position (S407). Additionally, the computing device 200 identifies one or more third positions capable of capturing images of unexplored areas on the structure that are different from the damaged area of the structure (S409), and may request movement of one or more second inspection robots to the third position (S411).

Through this processing, when the identity of the structure recognized based on camera images at the second position of the second inspection robot 300b and the damaged area are confirmed for the previously detected structure and damaged area, the computing device 200 may move the first inspection robot 300a and request LiDAR data acquisition of the structure at the second position to accurately confirm the 3D damage shape of the structure.

Accordingly, the clustering processing unit 2550g may perform clustering processing together on the point cloud data acquired corresponding to the first inspection robot 300a and the point cloud data acquired after the first inspection robot 300a moves to the position of the second inspection robot 300b. Accordingly, it becomes possible to generate 3D map visualization-based detection data including a more accurate 3D structural model corresponding to two or more positions for the target structure and a 3D damaged area of the 3D structural model.

Additionally, while the first inspection robot 300a is moving, a movement command for the second inspection robot 300b to the third position may be processed so that the second inspection robot 300b captures images of other sides of the structure not captured by the first inspection robot 300a and the second inspection robot 300b, thereby enabling efficient system operation.

The computing device 200 according to the embodiment may control a plurality of inspection robots to cooperate and more precisely detect damaged areas of a structure. For example, in addition to the first inspection robot 300a equipped with a LiDAR sensor, various configurations of inspection robots such as the second inspection robot 300b equipped only with a camera and the third inspection robot 300c equipped with both a LiDAR and a camera may be deployed at a single site, and each robot may be assigned different roles based on its sensor configuration. When a specific damaged area of a structure is primarily detected by the first inspection robot 300a, the first inspection robot may directly move for visualization and LiDAR-based 3D model generation of the entire damaged area, or another inspection robot located near the damaged area may move instead.

In order to determine which inspection robot to move, the computing device 200 comprehensively evaluates the crack clarity of the damaged area, the color diversity around the crack and the complexity of the structural background, the safety of the intended destination point (e.g., possibility of floor collapse), and the like. When cracks are relatively clear and simple, the second inspection robot not equipped with a LiDAR sensor may be deployed. A robot equipped with an infrared camera or a high-resolution optical camera may be preferentially assigned to areas with complex backgrounds or diverse detailed distributions. Additionally, when there is a need to transmit image data of the damaged area to the central server in real time, an inspection robot equipped with a high-speed communication module may be selected, which is particularly useful in underground structures or enclosed environments.

Furthermore, when subtle changes in the shape or pattern of previously detected cracks are detected based on images or sensor data captured by the inspection robot while approaching the damaged area or during the movement path, the computing device 200 may immediately reflect this to change the movement path or switch the mission to an inspection robot equipped with more suitable sensors at the position. For example, even though the second inspection robot equipped only with a camera was initially deployed to the crack position, if depth changes of the crack or surface micro-fracture expansion are detected during the approach, the first inspection robot equipped with a LiDAR sensor may be redeployed based on the information to additionally collect precise 3D data at the same position. Such redirection control may be performed by analyzing the expansion direction or branching pattern of cracks in real time, and may be automatically processed through real-time communication among multiple inspection robots or predefined cooperation protocols.

Additionally, efficient control may be provided even in structures where only some inspection robots are connectable to external communication networks (e.g., wireless LAN, LTE, etc.). Within an inspection robot cluster configured based on a local communication network, the roles of each robot may be dynamically distributed by comprehensively considering various factors such as the complexity of the damaged area, the terrain of the structure, and communication availability. Accordingly, optimal robot placement, path planning, and sensing equipment combinations may be automatically determined according to the environmental characteristics of the disaster site and the type of damage, thereby dramatically improving overall investigation efficiency and data precision.

The embodiments described above may be at least partially implemented as a computer program and recorded in a computer-readable recording medium. The computer-readable recording medium on which a program for implementing the embodiments is recorded includes all types of recording devices in which data readable by a computer is stored. Examples of the computer-readable recording medium include ROM, RAM, CD-ROM, magnetic tape, and optical data storage devices. Additionally, the computer-readable recording medium may be distributed in a computer system connected via a network, and computer-readable code may be stored and executed in a distributed manner. Additionally, functional programs, code, and code segments for implementing the present embodiments may be easily understood by those of ordinary skill in the art to which the present embodiments pertain.

The present disclosure described above has been described with reference to the embodiments shown in the drawings, but this is merely exemplary, and those of ordinary skill in the art will understand that various modifications and variations of the embodiments are possible therefrom. However, such modifications should be considered within the technical scope of the present disclosure. Therefore, the true technical scope of the present disclosure should be determined to include other implementations, other embodiments, and equivalents of the claims by the technical spirit of the appended claims.

1. An operating method of a computing device for detecting damage of a structure using one or more inspection robots, the method comprising the steps of:
acquiring camera image data collected through one or more cameras equipped on a first inspection robot and LiDAR data collected through one or more LiDAR sensors equipped on the first inspection robot, corresponding to the structure;
performing two-dimensional (2D) bounding box processing on image segments of a damaged area identified from the camera image data;
performing a three-dimensional (3D) frustum-based point pillar (Frustum Point Pillar) transformation corresponding to the 2D bounding box processed portion;
reconstructing 3D information by mapping depth map information generated using the LiDAR data onto an image selected corresponding to the 2D bounding box processed portion;
performing point cloud-based clustering by combining the 3D frustum-based point pillar (Frustum Point Pillar) transformed data and the reconstructed 3D information; and
configuring and outputting 3D spatial information visualization information for damage detection of the structure based on the clustering result information,
wherein the 3D spatial information visualization information includes 3D position information and 3D shape information corresponding to the damage detection of the structure.

2. The method of claim 1, further comprising:
identifying a first position at which the first inspection robot is located;
identifying one or more second positions capable of capturing images of the damaged area of the structure, using the 3D position information of the structure identified according to the 3D spatial information visualization information; and
transmitting a first movement request of the first inspection robot for the second position to the first inspection robot.

3. The method of claim 2, wherein the step of identifying the second position comprises:
identifying one or more second inspection robots that have captured images of the damaged area of the structure;
identifying photographing position information of the second inspection robot; and
mapping the photographing position information of the second inspection robot to the 3D position information of the structure identified according to the 3D spatial information visualization information, to identify the second position.

4. The method of claim 3, wherein the one or more second inspection robots are lightweight inspection robots not equipped with a LiDAR sensor.

5. The method of claim 3, further comprising:
identifying one or more third positions capable of capturing images of unexplored areas on the structure that are different from the damaged area of the structure, using the 3D position information and 3D shape information of the structure; and
transmitting a second movement request for moving the second inspection robot to the third position to the second inspection robot.

6. The method of claim 2, further comprising:
identifying a facility segment corresponding to a facility using the 3D spatial information visualization information;
acquiring, corresponding to the facility segment, visual crack identification information and crack depth change information determined by depth sensing information corresponding to the visual crack identification information;
estimating and calculating the degree of damage of the facility segment according to the presence or absence and scale of cracks acquired based on the visual crack identification information and the crack depth change information; and
configuring facility information analysis result data of the facility segment based on the degree of damage and outputting the configured data to one or more devices,
wherein the visual crack identification information includes start point and end point information of a visual crack object acquired through pixel information analysis performed corresponding to the facility segment using one or more camera images included in sensing information of the one or more cameras.

7. The method of claim 6, wherein:
the visual crack identification information includes a crack area image corresponding to the visual crack object,
the crack area image includes a color image in which color conversion has been processed for each pixel position using geometric transformation information corresponding to the visual crack object,
the geometric transformation information is acquired based on at least one of rotation information of an IMU sensor corresponding to the visual crack object and distance movement information to the first position,
the crack depth change information includes depth change information detected according to depth sensing information corresponding to the crack area image, and
the step of estimating and calculating the degree of damage comprises:
extracting crack skeletonization information composed of connecting lines of cracks based on the visual crack identification information and the crack depth change information; and
determining the scale of the cracks using the average length and thickness information of the cracks estimated from the crack skeletonization information.

8. The method of claim 7, wherein the step of identifying the second position comprises:
when an object estimated as a crack is identified in the damaged area of the structure, searching for an optimal position for acquiring the visual crack identification information and the crack depth change information corresponding to the crack according to the 3D spatial information visualization information, and from among the movable positions of the first inspection robot calculated based on sensing stability prediction of the first inspection robot, searching for one or more positions predicted to be capable of identifying the visual crack identification information and the crack depth change information of the object tracked as the crack at or above a threshold, as movement candidate positions; and
determining the second position from among the searched movement candidate positions.

9. A non-transitory computer-readable medium storing a computer program for causing a computer to execute the method of claim 1.

10. A computing device for analyzing damage of a structure by operating one or more inspection robots, the computing device comprising:
a sensor module driver configured to acquire camera image data collected through one or more cameras equipped on a first inspection robot and LiDAR data collected through one or more LiDAR sensors equipped on the first inspection robot, corresponding to the structure;
a frustum-based point pillar transformation unit configured to perform two-dimensional (2D) bounding box processing on image segments of a damaged area identified from the camera image data and to perform a three-dimensional (3D) frustum-based point pillar (Frustum Point Pillar) transformation corresponding to the 2D bounding box processed portion;
a 3D reconstruction unit configured to reconstruct 3D information by mapping depth map information generated using the LiDAR data onto an image selected corresponding to the 2D bounding box processed portion;
a clustering processing unit configured to perform point cloud-based clustering by combining the 3D frustum-based point pillar (Frustum Point Pillar) transformed data and the reconstructed 3D information; and
an output unit configured to configure and output 3D spatial information visualization information for damage detection of the structure based on the clustering result information,
wherein the 3D spatial information visualization information includes 3D position information and 3D shape information corresponding to the damage detection of the structure.

11. The computing device of claim 10, further comprising:
a robot driver configured to identify a first position at which the first inspection robot is located, identify one or more second positions capable of capturing images of the damaged area of the structure using the 3D position information of the structure identified according to the 3D spatial information visualization information, and transmit a first movement request of the first inspection robot for the second position to the first inspection robot.

12. The computing device of claim 11, wherein the robot driver is configured to:
identify one or more second inspection robots that have captured images of the damaged area of the structure,
identify photographing position information of the second inspection robot, and
map the photographing position information of the second inspection robot to the 3D position information of the structure identified according to the 3D spatial information visualization information, to identify the second position.

13. The computing device of claim 12, wherein:
the one or more second inspection robots are lightweight inspection robots not equipped with a LiDAR sensor, and
the robot driver is configured to identify one or more third positions capable of capturing images of unexplored areas on the structure that are different from the damaged area of the structure, using the 3D position information and 3D shape information of the structure, and transmit a second movement request for moving the second inspection robot to the third position to the second inspection robot.

14. The computing device of claim 12, further comprising:
a facility segment identification unit configured to identify a facility segment corresponding to a facility using the 3D spatial information visualization information;
a visual crack segment analysis unit configured to acquire, corresponding to the facility segment, visual crack identification information and crack depth change information determined by depth sensing information corresponding to the visual crack identification information; and
a damage extent detection unit configured to estimate and calculate the degree of damage of the facility segment according to the presence or absence and scale of cracks acquired based on the visual crack identification information and the crack depth change information,
wherein the output unit is configured to configure facility information analysis result data of the facility segment based on the degree of damage and output the configured data to one or more devices, and
the visual crack identification information includes start point and end point information of a visual crack object acquired through pixel information analysis performed corresponding to the facility segment using one or more camera images included in sensing information of the one or more cameras.

15. The computing device of claim 10, further comprising:
a robot driver configured to identify a first position at which the first inspection robot is located, identify one or more second positions capable of capturing images of the damaged area of the structure using the 3D position information of the structure identified according to the 3D spatial information visualization information, and transmit a first movement request of the first inspection robot for the second position to the first inspection robot,
wherein the robot driver is configured to identify one or more lightweight second inspection robots not equipped with a LiDAR sensor that have captured images of the damaged area of the structure, identify photographing position information of the second inspection robot, and map the photographing position information of the second inspection robot to the 3D position information of the structure identified according to the 3D spatial information visualization information, to identify the second position,
wherein the robot driver is configured to identify one or more third positions capable of capturing images of unexplored areas on the structure that are different from the damaged area of the structure, using the 3D position information and 3D shape information of the structure, and transmit a second movement request for moving the second inspection robot to the third position to the second inspection robot;
a facility segment identification unit configured to identify a facility segment corresponding to a facility using the 3D spatial information visualization information;
a visual crack segment analysis unit configured to acquire, corresponding to the facility segment, visual crack identification information and crack depth change information determined by depth sensing information corresponding to the visual crack identification information; and
a damage extent detection unit configured to estimate and calculate the degree of damage of the facility segment according to the presence or absence and scale of cracks acquired based on the visual crack identification information and the crack depth change information,
wherein the output unit is configured to configure facility information analysis result data of the facility segment based on the degree of damage and output the configured data to one or more devices,
the visual crack identification information includes start point and end point information of a visual crack object acquired through pixel information analysis performed corresponding to the facility segment using one or more camera images included in sensing information of the one or more cameras,
the visual crack identification information includes a crack area image corresponding to the visual crack object,
the crack area image includes a color image in which color conversion has been processed for each pixel position using geometric transformation information corresponding to the visual crack object,
the geometric transformation information is acquired based on at least one of rotation information of an IMU sensor corresponding to the visual crack object and distance movement information to the first position,
the crack depth change information includes depth change information detected according to depth sensing information corresponding to the crack area image,
the damage extent detection unit is configured to extract crack skeletonization information composed of connecting lines of cracks based on the visual crack identification information and the crack depth change information, and determine the scale of the cracks using the average length and thickness information of the cracks estimated from the crack skeletonization information, and
the robot driver is configured to, when an object estimated as a crack is identified in the damaged area of the structure, search for an optimal position for acquiring the visual crack identification information and the crack depth change information corresponding to the crack according to the 3D spatial information visualization information, and from among the movable positions of the first inspection robot calculated based on sensing stability prediction of the first inspection robot, search for one or more positions predicted to be capable of identifying the visual crack identification information and the crack depth change information of the object tracked as the crack at or above a threshold, as movement candidate positions, and determine the second position from among the searched movement candidate positions.
